(19) United States
(12) Patent Application Publication
(10) Pub. No.: US 2026/0056022 A1
(43) Pub. Date: Feb. 26, 2026

(54) METHOD AND APPARATUS FOR PROVIDING USER-PREFERRED ROUTE

(71) Applicant: HYUNDAI AUTOEVER CORP., Seoul (KR)

(72) Inventors: Ji Eun LEE, Seoul (KR); Yeo Sook HYUN, Seoul (KR); Ji Hyang KIM, Seoul (KR)

(21) Appl. No.: 19/304,708

(22) Filed: Aug. 20, 2025

(30) Foreign Application Priority Data
Aug. 20, 2024 (KR) 10-2024-0110870

(51) Int. Cl. G01C 21/34; G01C 21/36

(52) U.S. Cl. CPC G01C 21/3484; G01C 21/3667

(57) ABSTRACT

Methods and devices for providing a user-preferred route are described. According to one embodiment, the method comprises receiving, from a user terminal, information on a route search request including information on a departure point and information on a destination point, acquiring first data on a plurality of actual driving routes of a user for reaching the destination point and second data on a number of times each of the plurality of actual driving routes has been driven, the plurality of actual driving routes being associated with the departure point, generating a preferred route from the departure point to the destination based on the first data and the second data, and providing the preferred route to the user terminal.

### CROSS-REFERENCE TO RELATED APPLICATION

This application claims priority from Korean Patent Application No. 10-2024-0110870 filed on Aug. 20, 2024, in the Korean Intellectual Property Office, and all the benefits accruing therefrom under 35 U.S.C. 119, the contents of which in its entirety are herein incorporated by reference.

### BACKGROUND

### 1. Field

The present disclosure relates to a method and apparatus for providing a user-preferred route and, more particularly, to a method for providing a user-customized preferred route from a departure point to a destination, by using data related to the user's actual driving history, and an apparatus for implementing the method.

### 2. Description of the Related Art

Conventionally, when a user inputs a departure point and a destination, a navigation device provides various routes from the departure point to the destination using several options. These options may include, for example, a real-time fastest route, a shortest-distance route, a toll-free priority route, and a route using a specific road. The user selects one of these options and uses a route based on the selected option.

Despite offering various options as described above, users often drive along routes other than the provided ones. For example, users tend to use personalized routes that are more convenient for them, routes they are familiar with from repeated driving, or faster routes known only to them. In particular, for habitual routes frequently travel, users tend to follow their own preferred and familiar paths rather than those provided based on the search options.

Meanwhile, such user-preferred routes do not follow specific trends. For example, users may prefer to drive on wide roads, but do not always take wide roads on every route.

Similarly, they may prefer routes without traffic signals, but do not always choose routes without traffic signals. For these reasons, providing individualized preferred routes becomes even more challenging.

### SUMMARY

An objective of the present disclosure is to provide a method and apparatus for providing a user-customized preferred route based on routes actually driven by a user.

Another objective of the present disclosure is to provide a method and apparatus for providing a user-preferred route together with a route searched based on default navigation options.

The objectives of the present disclosure are not limited to those mentioned above, and other objectives not explicitly stated will be clearly understood by those skilled in the art based on the following description.

According to an aspect of the present disclosure, there is provided a method performed by a computing device for providing a user-preferred route. The method may comprise: receiving information on a route search request, including information on a departure point and information on a destination, from a user terminal; acquiring data on a plurality of actual driving routes of a user for reaching the destination and data on a number of times each of the plurality of actual driving routes has been driven, the plurality of actual driving routes being associated with the departure point; generating a preferred route from the departure point to the destination based on the acquired data; and providing the generated preferred route to the user terminal.

In some embodiments, the data may have been collected during a preset period before a time point of the route search request.

In some embodiments, the plurality of actual driving routes may include a first actual driving route and a second actual driving route different from the first actual driving route, and the acquiring of the data may comprise: comparing the first actual driving route with the second actual driving route; and in response to a result of the comparison indicating that a difference between the first and second actual driving routes falls within a preset range, integrating data on the first actual driving route and data on the second actual driving route.

In some embodiments, the generating of the preferred route may comprise generating the preferred route using an actual driving route having a number of driving times equal to or greater than a preset threshold, among the plurality of actual driving routes.

In some embodiments, the generating of the preferred route may comprise, when there are multiple actual driving paths with the number of driving times equal to or greater than the preset threshold, generating the preferred route using an actual driving route having a greatest number of driving times among the multiple actual driving routes.

In some embodiments, the generating of the preferred route may comprise generating a first connection route that connects the departure point and the actual driving route having the number of driving times equal to or greater than the preset threshold.

In some embodiments, the generating of the preferred route may comprise generating a second connection route that connects the actual driving route with the number of driving times equal to or greater than the preset threshold and the destination.

According to the aforementioned and other embodiments of the present disclosure, there is provided a method performed by a computing device for providing a user-preferred route. The method may comprise: receiving a user input requesting a route search to a destination; receiving information on a default route to the destination, the default route being generated based on a default search option; receiving information on a preferred route to the destination, the preferred route being generated based on data on a plurality of actual driving routes of a user for reaching the destination and data on a number of times each of the plurality of actual driving routes has been driven; determining, based on a comparison result between the default route and the preferred route, whether to display the preferred route; and in response to the preferred route being determined to be displayed, displaying the preferred route along with the default route on a screen of the user terminal.

In some embodiments, the receiving of the user input may comprise receiving a user input selecting one of a plurality of default search options, and the default route is generated based on the default search option selected by the user.

In some embodiments, the plurality of default search options may include at least one of a fastest route search, a recommended route search, an economical route search, an expressway-priority route search, and a toll-free road-priority route search.

In some embodiments, the determining of whether to display the preferred route may comprise: determining not to display the preferred route when the default route and the preferred route are the same, and determining to display the preferred route when the default route and the preferred route are different.

In some embodiments, the displaying of the preferred route may comprise displaying the default route and the preferred route on a map image to be visually distinguishable.

In some embodiments, the displaying of the preferred route may comprise: displaying travel distance information and travel time information corresponding to the default route; and displaying travel distance information and travel time information corresponding to the preferred route.

According to the aforementioned and other embodiments of the present disclosure, there is provided a computing device comprising: at least one processor; a communication interface configured to communicate with an external device; a memory configured to load a computer program executed by the processor; and a storage configured to store the computer program. The computer program may include instructions for performing operations of: receiving information on a route search request, including information on a departure point and information on a destination, from a user terminal; acquiring data on a plurality of actual driving routes of a user for reaching the destination and data on a number of times each of the plurality of actual driving routes has been driven, the plurality of actual driving routes being associated with the departure point; generating a preferred route from the departure point to the destination based on the acquired data; and providing the generated preferred route to the user terminal.

In some embodiments, the plurality of actual driving routes may include a first actual driving route and a second actual driving route different from the first actual driving route, and the operation of acquiring the data comprises: comparing the first actual driving route with the second actual driving route; and in response to a result of the comparison indicating that a difference between the first and second actual driving routes falls within a preset range, integrating data on the first actual driving route and data on the second actual driving route.

In some embodiments, the operation of generating the preferred route may comprise generating the preferred route using an actual driving route having a number of driving times equal to or greater than a preset threshold, among the plurality of actual driving routes.

In some embodiments, the operation of generating the preferred route may comprise, when there are multiple actual driving routes with the number of driving times equal to or greater than the preset threshold, generating the preferred route using an actual driving route having a greatest number of driving times among the multiple actual driving routes.

In some embodiments, the operation of generating the preferred route may comprise generating a first connection route that connects the departure point and the actual driving route having the number of driving times equal to or greater than the preset threshold.

In some embodiments, the operation of generating the preferred route may include generating a second connection route that connects the actual driving route having the number of driving times equal to or greater than the preset threshold and the destination.

According to the aforementioned and other embodiments of the present disclosure, there is provided a computing device comprising: a communication interface configured to communicate with an external device; a memory configured to load a computer program executed by the processor; and a storage configured to store the computer program. The computer program may include instructions for performing operations of: receiving a user input requesting a route search to a destination; receiving information on a default route to the destination, the default route being generated based on a default search option; receiving information on a preferred route to the destination, the preferred route being generated based on data on a plurality of actual driving routes of a user for reaching the destination and data on a number of times each of the plurality of actual driving routes has been driven; determining, based on a comparison result between the default route and the preferred route, whether to display the preferred route; and in response to the preferred route being determined to be displayed, displaying the preferred route along with the default route on a screen of the user terminal.

### BRIEF DESCRIPTION OF THE DRAWINGS

The above and other aspects and features of the present disclosure will become more apparent by describing exemplary embodiments thereof in detail with reference to the attached drawings, in which:

FIG. 1 schematically illustrates an environment in which a route search service system for providing a user-preferred route according to an embodiment of the present disclosure may be applied;

FIG. 2 is a flowchart for explaining a method for providing a user-preferred route according to an embodiment of the present disclosure;

FIG. 3 is a diagram for describing data on a user's actual driving history, which may be referenced in some embodiments of the present disclosure;

FIG. 4 is a diagram for explaining the operation of generating a preferred route, which may be referenced in some embodiments of the present disclosure;

FIG. 5 is a diagram for explaining the operation of generating a connection route, which may be referenced in some embodiments of the present disclosure;

FIG. 6 is a flowchart for explaining a method for providing a user-preferred route according to another embodiment of the present disclosure;

FIG. 7 schematically illustrates a screen of a navigation device in which a user-preferred route is displayed according to an embodiment of the present disclosure; and

FIG. 8 is a block diagram illustrating the hardware configuration of a computing device for providing a user-preferred route according to an embodiment of the present disclosure.

### DETAILED DESCRIPTION

Hereinafter, preferred embodiments of the present disclosure will be described with reference to the attached drawings. Advantages and features of the present disclosure and methods of accomplishing the same may be understood more readily by reference to the following detailed description of preferred embodiments and the accompanying drawings. The present disclosure may, however, be embodied in many different forms and should not be construed as being limited to the embodiments set forth herein. Rather, these embodiments are provided so that this disclosure will be thorough and complete and will fully convey the concept of the disclosure to those skilled in the art, and the present disclosure will only be defined by the appended claims.

In adding reference numerals to the components of each drawing, it should be noted that the same reference numerals are assigned to the same components as much as possible even though they are shown in different drawings. In addition, in describing the present disclosure, when it is determined that the detailed description of the related well-known configuration or function may obscure the gist of the present disclosure, the detailed description thereof will be omitted.

Unless otherwise defined, all terms used in the present specification (including technical and scientific terms) may be used in a sense that can be commonly understood by those skilled in the art. In addition, the terms defined in the commonly used dictionaries are not ideally or excessively interpreted unless they are specifically defined clearly. The terminology used herein is for the purpose of describing particular embodiments only and is not intended to be limiting of the disclosure. In this specification, the singular also includes the plural unless specifically stated otherwise in the phrase.

In addition, in describing the component of this disclosure, terms, such as first, second, A, B, (a), (b), can be used. These terms are only for distinguishing the components from other components, and the nature or order of the components is not limited by the terms. If a component is described as being “connected,” “coupled” or “contacted” to another component, that component may be directly connected to or contacted with that other component, but it should be understood that another component also may be “connected,” “coupled” or “contacted” between each component.

Hereinafter, embodiments of the present disclosure will be described with reference to the attached drawings.

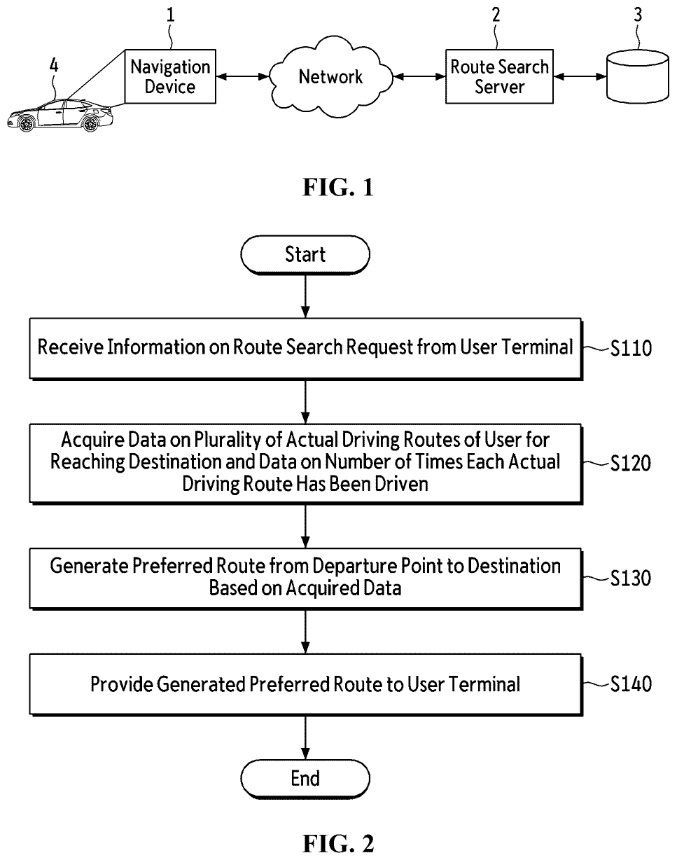

FIG. 1 schematically illustrates an environment in which a route search service system for providing a user-preferred route according to an embodiment of the present disclosure may be applied.

As illustrated in FIG. 1, the route search service system includes a navigation device 1 provided in a mobility device 4 and a route search server 2. The navigation device 1 and the route search server 2 are connected via a network. The route search server 2 is connected to a database 3 that stores traffic information and user driving history information via the network and may retrieve data stored in the database 3. The traffic information and the user driving history information stored in the database 3 may be stored in the same physical database server or in different database servers.

The navigation device 1 is a user terminal on which an application capable of performing a navigation function is installed. When a user inputs a destination into the navigation device 1, the navigation device 1 may transmit information on a route search request for the destination to the route search server 2. The information on the route search request may include information on a departure point and information on the destination. The departure point indicates a location corresponding to the current position of the mobility device 4 at the time the user inputs the destination into the navigation device 1, and the destination indicates a location corresponding to the destination input or selected by the user.

The route search server 2 may receive the information on the route search request from the navigation device 1 and may generate a preferred route from the departure point to the destination by using the traffic information and user driving history information stored in the database 3. Specifically, the route search server 2 may acquire (or extract) data on a plurality of actual driving routes of the user for reaching the destination and data on the number of times each of the actual driving routes has been driven from the database 3 by using the information on the departure point and the destination, and may generate a preferred route from the departure point to the destination based on the acquired data. A detailed description of a specific method for generating the preferred route will be provided in the description of other embodiments below.

In addition to the user-preferred route, the route search server 2 may generate a default route based on a plurality of default search options. For example, the route search server 2 may provide a route search option for a fastest route search, a recommended route search, an economical route search, an expressway-priority route search, or a toll-free road-priority route search, and based on these options, may generate a fastest route, a recommended route, an economical route, an expressway-priority route, and/or a toll-free road-priority route to the destination.

The route search server 2 may provide, to the navigation device 1, a preferred route generated based on the user's actual driving routes and the number of times each of the actual driving routes has been driven. The navigation device 1 may display the preferred route received from the route search server 2 on a screen.

For example, the navigation device 1 may determine whether to display the preferred route based on a result of comparing the default route with the preferred route, and in response to a determination that the preferred route is to be displayed, may display the preferred route along with the default route. That is, when the preferred route is not the same as the default route, information on the preferred route may be provided and displayed. In some embodiments, the navigation device 1 may provide and display only the preferred route.

The database 3 may be implemented as one or more computer systems that collect, accumulate, and/or manage data on the user's actual driving history. The data on the user's actual driving history may include data on a plurality of actual driving routes of the user for reaching each destination and data on the number of times each of the actual driving routes has been driven. Here, the data on the user's actual driving routes may consist of a plurality of actual driving routes for respective departure point-destination pairs, and each of these actual driving routes may be composed of a sequence of links (linkid, linkid, linkid, . . . , linkid).

Specifically, by converting the user's trajectory data composed of point data into line data through map link matching, a link sequence corresponding to each actual driving route may be extracted and generated. At this time, due to the incompleteness of the trajectory data, it may be difficult to extract a link sequence that is completely connected from the departure point to the destination. Accordingly, in the present disclosure, a route corresponding to a region (e.g., an administrative region in which the departure point or the destination belongs), rather than the exact positions of the departure point and destination, may be generated. In summary, the data on the user's actual driving routes may include identification information (e.g., an encrypted device-specific identifier) of the user terminal of the user, i.e., the navigation device 1, identification information (e.g., an administrative code of the region where the departure point is located) of the departure region, identification information (e.g., an administrative code of the region where the destination is located) of the destination region, and information on the link sequence (linkid, linkid, linkid,. linkid) corresponding to each actual driving route from the departure region to the destination region.

In one embodiment, the database 3 may collect, accumulate, and/or manage driving history data for a predetermined period. For example, the driving history data for the past one month may be collected, accumulated, and/or managed. To this end, the user's actual driving history data for the predetermined period may be accumulated at each update time through a daily batch process that updates the dataset at a set time each day.

In one embodiment, the database 3 may collect, accumulate, and/or manage the actual driving routes for respective departure point-destination pairs that have been frequently driven during the predetermined period. For example, the top five departure point-destination pairs that the user has searched or driven two or more times during the predetermined period may be selected, and the actual driving routes for the selected top five departure point-destination pairs may be collected.

So far, the components included in an exemplary environment in which the route search service system for providing a user-preferred route may be applied, and operations that may be performed by those components, have been described with reference to FIG. 1. The above-described embodiments may be understood in greater detail with reference to other embodiments that will be described below. In addition, the technical ideas that may be understood through the above-described embodiments may be reflected in other embodiments described later, even if not explicitly stated.

A method for providing a user-preferred route according to an embodiment of the present disclosure will hereinafter be described in detail with reference to FIG. 2 and subsequent drawings.

FIG. 2 is a flowchart for explaining a method for providing a user-preferred route according to an embodiment of the present disclosure. It should be noted that this is merely a preferred embodiment for achieving the objectives of the present disclosure, and some steps may be added or omitted as necessary.

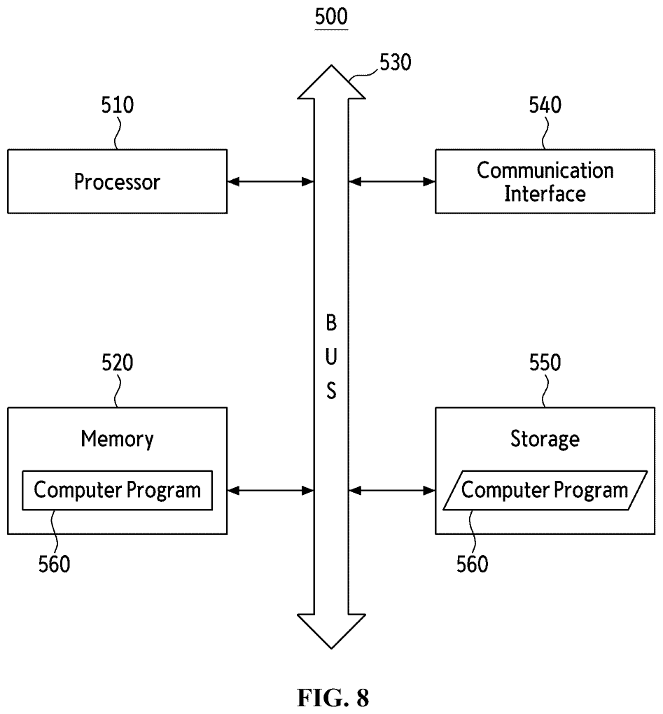

Also, the method illustrated in FIG. 2 may be executed by the navigation device 1 or the route search server 2 illustrated in FIG. 1. The navigation device 1 or the route search server 2 that executes the method may be a computing device illustrated in FIG. 8. Meanwhile, the subject that performs some operations or steps included in the method may be omitted in the description, and in such cases, it should be understood that the subject is the computing device.

As illustrated in FIG. 2, the method starts with step S110, where information on a route search request is received from a user terminal. For example, when a user inputs a destination on a screen of the user terminal, the user terminal may transmit, to the route search server, the information on the route search request, which includes information on a departure point corresponding to the current location of the user and information on the destination input by the user.

Thereafter, in step S120, data on a plurality of actual driving routes of the user for reaching the destination and data on the number of times each of the actual driving routes has been driven may be acquired. In this case, the actual driving routes may all be associated with the departure point. That is, the actual driving routes may represent routes that the user has actually driven from the departure point or departure region to the destination.

The computing device may extract, from the database, the user's actual driving history data (i.e., data on the actual driving routes and data on the number of times each of the actual driving routes has been driven) by using identification information (e.g., an encrypted device number) of the user terminal that has sent the route search request, and by using the information on the departure point and destination, may identify and extract data related to the departure point and destination from among the extracted actual driving history data.

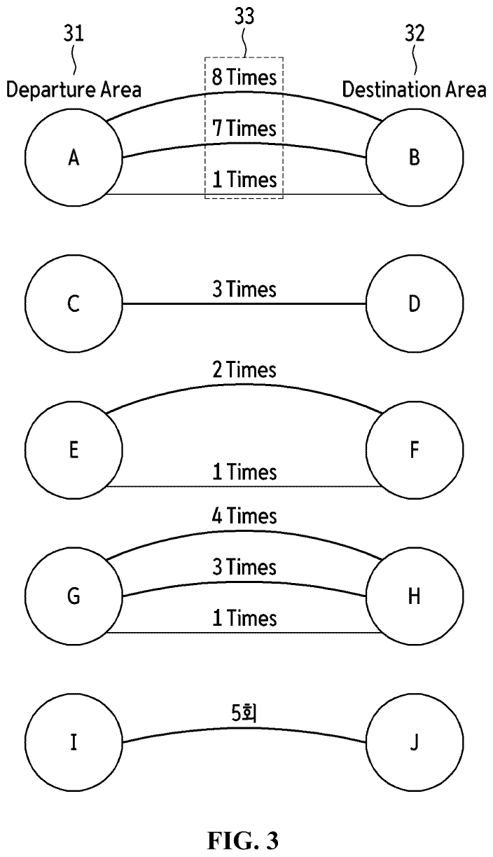

FIG. 3 is a diagram for describing a user's actual driving history data, which may be referenced in some embodiments of the present disclosure.

Referring to FIG. 3, the user's actual driving history data may include data on actual driving routes corresponding to each departure point-destination pair that the user has frequently traveled during a predetermined period and the number of times each of these actual driving routes has been driven. Specifically, the user's actual driving history data may include data on driving routes corresponding to each of the top five departure point-destination pairs frequently traveled during the predetermined period and the number of times each of these driving routes has been driven. In this case, the driving routes corresponding to each departure point- destination pair may be routes corresponding to each departure region-destination region pair that represents an administrative region to which the corresponding departure point (or destination) belongs (e.g., region A to region B, region C to region D, region E to region F, region G to region H, or region I to region J).

For example, when the user's current location belongs to region A and the user requests a route search to a destination in region B, data on three actual driving routes corresponding to the region A-region B pair and the number of times (33) each of the three driving routes has been driven (e.g., 8 times, 7 times, and 1 time) may be extracted and acquired.

In one embodiment, step S120, where data on actual driving routes is acquired, may include integrating the data on the actual driving routes. Specifically, when a plurality of actual driving routes corresponding to the departure point-destination pair include a first actual driving route and a second actual driving route different from the first actual driving route, the first and second actual driving routes may be compared. If the result of the comparison shows that the difference between the first and second actual driving routes falls within a predetermined range, data on the first actual driving route and data on the second actual driving route may be integrated.

Specifically, even if the actual driving routes corresponding to the departure point- destination pair are not completely identical, if a comparison of their link sequences reveals an inclusion relationship, the shorter link sequence may be converted into the longer link sequence, thereby integrating the data on the number of times each of the driving routes has been driven. Meanwhile, the data on the actual driving routes has been described as being integrated during the process of acquiring data, but may be integrated and managed during the process of collecting and accumulating data in the database, according to the operations described above.

Referring again to FIG. 2, based on the data acquired in step S120, a preferred route from the departure point to the destination may be generated (S130). Specifically, the preferred route may be generated using one or more actual driving routes among the plurality of actual driving routes of the user, each having a number of driving times equal to or greater than a predetermined threshold. If there are multiple actual driving routes that meet the predetermined threshold, the preferred route may be generated using the actual driving route with the greatest number of driving times. The predetermined threshold may be, for example, two or three times, but is not limited thereto. The predetermined threshold may be set in consideration of the user's driving pattern, total number of driving times, and the like.

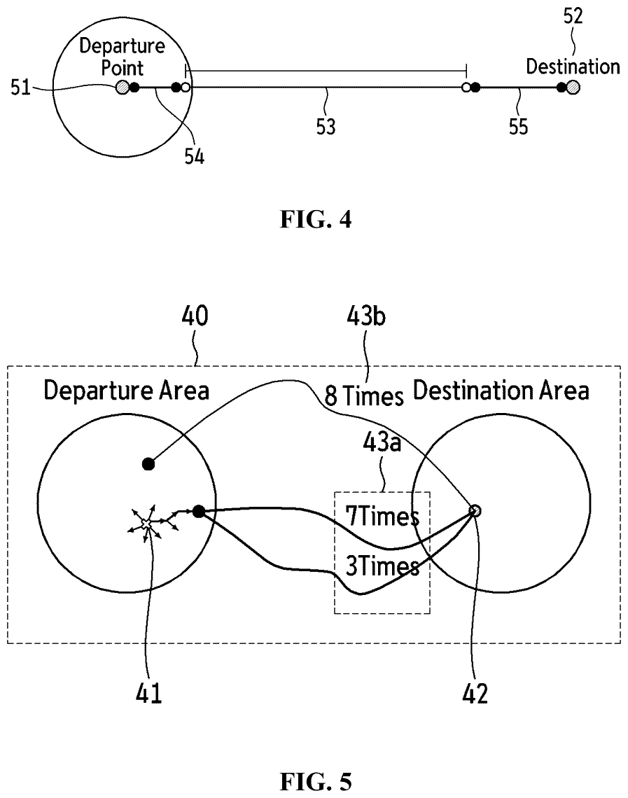

FIG. 4 is a diagram for explaining the operation of generating a preferred route, which may be referenced in some embodiments of the present disclosure. Specifically, FIG. 4 illustrates an example where, in response to a request for the search of a route from a departure point 41 to a destination 42, data 40 on driving routes for the corresponding departure region—destination region pair is acquired.

As illustrated in FIG. 4, when the data 40 includes multiple driving routes or multiple sets of driving routes, a radial search may first be performed based on the departure point 41, such that links are expanded around the departure point 41. Among the expanded links, a first driving route set 43a that has been reached first may be identified and extracted. Then, based on the number of driving times for each driving route included in the first driving route set 43a, an actual driving route with the greatest number of driving times may be extracted, and a preferred route may be generated using the extracted actual driving route.

In one embodiment, step S130, where a preferred route is generated, may include generating a first connection route that connects the departure point and the actual driving route whose number of driving times meets or exceeds the predetermined threshold. In addition, step S130 may also include generating a second connection route that connects the actual driving route and the destination.

FIG. 5 is a diagram for explaining the operation of generating a connection route, which may be referenced in some embodiments of the present disclosure.

As illustrated in FIG. 5, among the actual driving routes from a departure point 51 to a destination 52, an actual driving route 53 whose number of driving times meets or exceeds the predetermined threshold may be a route from a departure region including the departure point 51 to a destination region including the destination 52, rather than a route from the exact position of the departure point 51 to the exact position of the destination 52. In other words, a gap may exist between the actual driving route 53 and the departure point 51. In some cases, a gap may also exist between the actual driving route 53 and the destination 52. Accordingly, a complete route from the departure point 51 to the destination 52 may be generated through an additional process of generating a connection route that connects the actual driving route 53 with the departure point 51 and/or with the destination 52 and combining the connection route(s) and the actual driving route 53.

Specifically, a first connection route 54 connecting the departure point 51 and an endpoint of the actual driving route 53 adjacent to the departure point 51 may be generated. In some cases, a second connection route 55 connecting the destination 52 and an endpoint of the actual driving route 53 adjacent to the destination 52 may additionally be generated. As a result, a preferred route from the departure point 51 to the destination 52 may be generated as 54+53+55.

A method for providing a user-preferred path according to another embodiment of the present disclosure will hereinafter be described.

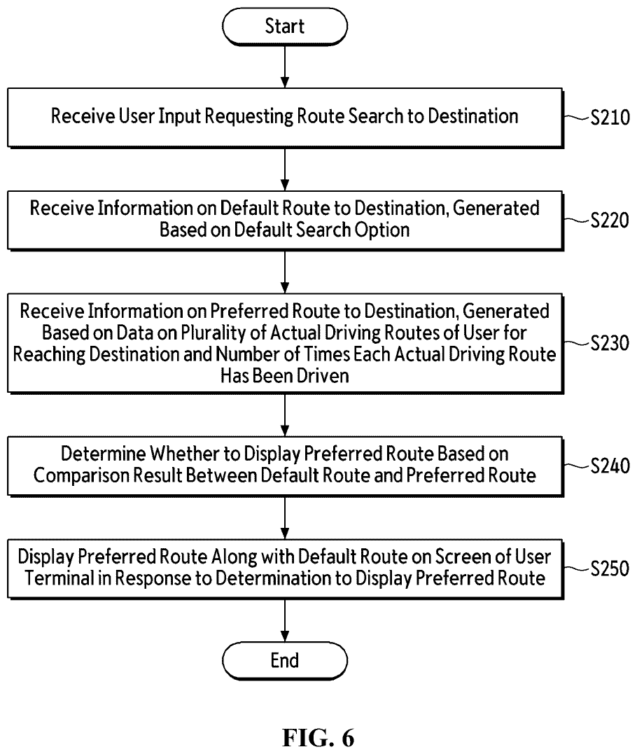

FIG. 6 is a flowchart for explaining a method for providing a user-preferred path according to another embodiment of the present disclosure. It should be noted that this is merely a preferred embodiment for achieving the objectives of the present disclosure, and some steps may be added or omitted as necessary.

In addition, the method illustrated in FIG. 6 may be executed by the navigation device 1 or the route search server 2 illustrated in FIG. 1. The navigation device 1 or the route search server 2 that executes the method may be the computing device illustrated in FIG. 8.

Meanwhile, the subject that performs some operations or steps included in the method may be omitted in the description, and in such cases, it should be understood that the subject is the computing device.

Referring to FIG. 6, the method starts with step S210, where a user input requesting a route search to a destination is received. For example, the user may request a route search to a destination by searching for and selecting the destination on the screen of a user terminal. When the user input is received, the user terminal may transmit, to a route search server, route search request information including information on a departure point corresponding to the user's current location and information on the destination input by the user. Here, the user terminal may be a navigation device.

In one embodiment, the step of receiving the user input, i.e., step S210, may include receiving a user input for selecting one of a plurality of default search options. For example, when the user requests a route search to a destination, a plurality of default search options may be displayed on the screen of the user terminal, and the user may select one of the plurality of default search options. Here, the plurality of default search options are basic search options corresponding to route search algorithms provided by the user terminal, and a default route to be described later, may be generated based on the default search option selected by the user.

Thereafter, in step S220, information on a default route to the destination, generated based on the selected default search option, may be received. The route search server may generate a default route to the destination based on the default search option selected by the user and may transmit information on the generated default route to the user terminal. The plurality of default search options may include at least one of a fastest route search, a recommended route search, an economical route search, an expressway-priority route search, or a toll-free road-priority route search.

Thereafter, in step S230, information on a preferred route to the destination, generated based on the user's actual driving routes and the number of times each of the actual driving routes has been driven, may be received. For details on the generation of the preferred route to the destination, the previous embodiments may be referenced.

Thereafter, in step S240, based on the result of comparing the default route and the preferred route, it may be determined whether to display the preferred route. In step S250, in response to a determination that the preferred route is to be displayed, the preferred route may be displayed on the screen of the user terminal along with the default route. Specifically, if the comparison result indicates that the default route and the preferred route are the same, the preferred route may be determined not to be displayed. If the default route and the preferred route are different, the preferred route may be determined to be displayed.

In one embodiment, the default route and the preferred route may be displayed to be visually distinguishable from each other. Specifically, on a map image, the departure point, the destination, and each route connecting the departure point and the destination may be displayed as a line, and the default route and the preferred route may be displayed to be visually distinguishable from each other. For example, the default route and the preferred route may be displayed in different colors. Accordingly, the user may easily identify and compare the default route and the preferred route.

In one embodiment, travel distance information and travel time information corresponding to the default route may be displayed along with the default route, and travel distance information and travel time information corresponding to the preferred route may also be displayed along with the preferred route. For example, speech bubbles containing travel distance information and travel time information corresponding to the default route/the preferred route may be displayed near the default route/the preferred route.

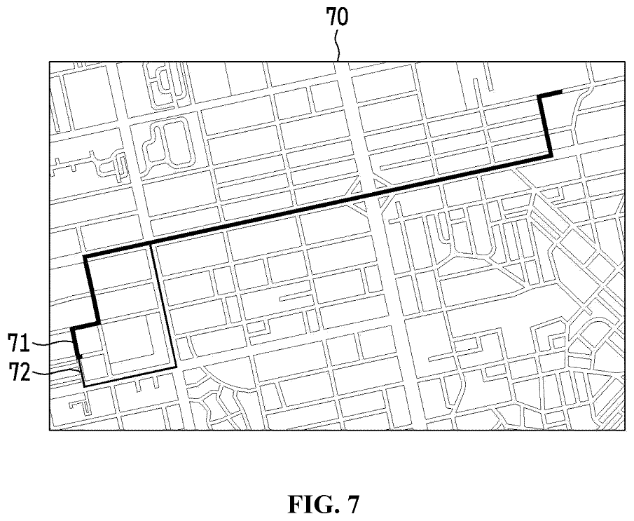

FIG. 7 is a diagram schematically illustrating a screen of a navigation device in which a user-preferred route is displayed according to an embodiment of the present disclosure.

As illustrated in FIG. 7, a map image 70 may be displayed on the screen of the navigation device, and a preferred route 71 and a default route 72 may be displayed together on the map image 70. The user may easily identify and compare the preferred route 71 and the default route 72, and may drive according to the preferred route 71 or the default route 72 depending on the situation.

According to various embodiments of the present disclosure as described above, in a route search for reaching a destination, a user-customized preferred route may be provided based on routes the user has actually driven. In addition, the search result may be provided to allow the user to compare a user-preferred route with routes searched based on time, distance, and the like.

FIG. 8 is a block diagram illustrating the hardware configuration of a computing device for providing a user-preferred route according to an embodiment of the present disclosure. Referring to FIG. 8, a computing device 500 may include at least one processor 510, a bus 530, a communication interface 540, a memory 520 that loads a computer program 560 executed by the processor 510, and a storage 550 that stores the computer program 560. However, since only components relevant to the embodiments of the present disclosure are illustrated in FIG. 8, one of ordinary skill in the art to which the present disclosure pertains will recognize that other general-purpose components may also be included in addition to the components depicted in FIG. 8. That is, the computing device 500 may include various additional components besides those illustrated in FIG. 8. Additionally, in some embodiments, the computing device 500 may be configured such that some of the components in FIG. 8 are omitted. The components of the computing device 500 will hereinafter be described.

The processor 510 may control the overall operation of each component of the computing device 500. The processor 510 may include at least one of a central processing unit (CPU), a micro processor unit (MPU), a micro controller unit (MCU), a graphics processing unit (GPU), or any type of processor well known in the relevant technical field of the present disclosure. The processor 510 may also perform computations for at least one application or program for executing operations/methods according to various embodiments of the present disclosure. The computing device 500 may include one or more processors 510.

The memory 520 may store various data, commands, and/or information. The memory 520 may load the computer program 560 from the storage 550 in order to execute the operations/methods according to various embodiments of the present disclosure. The memory 520 may be implemented as volatile memory such as RAM, but the present disclosure is not limited thereto.

The bus 530 may provide communication functionality between the components of the computing device 500. The bus 530 may be implemented as various types of buses, such as an address bus, a data bus, and a control bus.

The communication interface 540 may support wired or wireless internet communication of the computing device 500. Additionally, the communication interface 540 may support various communication methods other than Internet communication. To this end, the communication interface 540 may include a communication module well known in the technical field of the present disclosure.

The storage 550 may non-transitorily store one or more computer programs 560. The storage 550 may include a non-volatile memory such as read-only memory (ROM), erasable programmable ROM (EPROM), electrically erasable programmable ROM (EEPROM), flash memory, a hard disk, a removable disk, or any form of computer-readable recording medium well known in the technical field of the present disclosure.

The computer program 560, when loaded into the memory 520, may include one or more instructions that cause the processor 510 to perform the operations/methods according to various embodiments of the present disclosure. That is, by executing the instructions once loaded, the processor 510 may perform the operations/methods according to various embodiments of the present disclosure.

For example, the computer program 560 may include instructions for performing the operations of: receiving information on a route search request, including information on a departure point and information on a destination, from a user terminal; acquiring data on a plurality of driving routes of a user for reaching the destination and data on the number of times each of the plurality of driving routes has been driven, the plurality of driving routes being associated with the departure point; generating a preferred route from the departure point to the destination based on the acquired data; and providing the generated preferred route to the user terminal.

In another example, the computer program 560 may include one or more instructions for performing the operations of: receiving a user input requesting a route search to a destination; receiving information on a default route to the destination, the default route being generated based on a default search option; receiving information on a preferred route to the destination, the preferred route being generated based on data on a plurality of driving routes of a user for reaching the destination and data on the number of times each of the plurality of driving routes has been driven; determining, based on a comparison result between the default route and the preferred route, whether to display the preferred route; and in response to a determination that the preferred route is to be displayed, displaying the preferred route along with the default route on a screen of the user terminal.

So far, a variety of embodiments of the present disclosure and the effects according to embodiments thereof have been mentioned with reference to FIGS. 1 to 8. The effects according to the technical idea of the present disclosure are not limited to the forementioned effects, and other unmentioned effects may be clearly understood by those skilled in the art from the description of the specification.

The technical features of the present disclosure described so far may be embodied as computer readable codes on a computer readable medium. The computer readable medium may be, for example, a removable recording medium (CD, DVD, Blu-ray disc, USB storage device, removable hard disk) or a fixed recording medium (ROM, RAM, computer equipped hard disk). The computer program recorded on the computer readable medium may be transmitted to other computing device via a network such as internet and installed in the other computing device, thereby being used in the other computing device.

Although operations are shown in a specific order in the drawings, it should not be understood that desired results can be obtained when the operations must be performed in the specific order or sequential order or when all of the operations must be performed. In certain situations, multitasking and parallel processing may be advantageous. According to the above-described embodiments, it should not be understood that the separation of various configurations is necessarily required, and it should be understood that the described program components and systems may generally be integrated together into a single software product or be packaged into multiple software products.

In concluding the detailed description, those skilled in the art will appreciate that many variations and modifications can be made to the preferred embodiments without substantially departing from the principles of the present disclosure. Therefore, the disclosed preferred embodiments of the disclosure are used in a generic and descriptive sense only and not for purposes of limitation.

What is claimed is:

1. A method for providing a user-preferred route, performed by a computing device, the method comprising:
receiving, from a user terminal, information on a route search request including information on a departure point and information on a destination point;
acquiring first data on a plurality of actual driving routes of a user for reaching the destination point and second data on a number of times each of the plurality of actual driving routes has been driven, the plurality of actual driving routes being associated with the departure point;
generating a preferred route from the departure point to the destination point based on the first data and the second data; and
providing the preferred route to the user terminal.

2. The method of claim 1, wherein the generating of the preferred route from the departure point comprises third data has collected during a preset period before a time point of the route search request.

3. The method of claim 1, wherein
the plurality of actual driving routes includes a first actual driving route and a second actual driving route different from the first actual driving route, and
the acquiring of the first data comprises: comparing the first actual driving route with the second actual driving route; and when a difference between the first actual driving route and the second actual driving route falls within a preset range, integrating data on the first actual driving route and data on the second actual driving route.

4. The method of claim 1, wherein the generating of the preferred route comprises generating the preferred route using, among the plurality of actual driving routes, an actual driving route having a number of driving times equal to or greater than a preset threshold.

5. The method of claim 4, wherein the generating of the preferred route comprises, when there are multiple actual driving routes with the number of driving times equal to or greater than the preset threshold, generating the preferred route using an actual driving route having a greatest number of driving times among the multiple actual driving routes.

6. The method of claim 4, wherein the generating of the preferred route comprises generating a first connection route that connects the departure point and the actual driving route having the number of driving times equal to or greater than the preset threshold.

7. The method of claim 4, wherein the generating of the preferred route comprises generating a second connection route that connects the actual driving route with the number of driving times equal to or greater than the preset threshold and the destination point.

8. A method for providing a user-preferred route, performed by a computing device, the method comprising:
receiving a user input requesting a route search to a destination;
receiving information on a default route to the destination, the default route being generated based on a default search option;
receiving information on a preferred route to the destination, the preferred route being generated based on data on a plurality of actual driving routes of a user for reaching the destination and data on a number of times each of the plurality of actual driving routes has been driven;
determining, based on a comparison result between the default route and the preferred route, whether to display the preferred route; and
in response to the preferred route being determined to be displayed, displaying the preferred route along with the default route on a screen of a user terminal.

9. The method of claim 8, wherein
the receiving of the user input comprises selecting one of a plurality of default search options in response to the receiving of the user input, and
the default route is generated based on the default search option when the default search option is selected by the user.

10. The method of claim 9, wherein the plurality of default search options includes at least one of a fastest route search, a recommended route search, an economical route search, an expressway-priority route search, and a toll-free road-priority route search.

11. The method of claim 8, wherein the determining of whether to display the preferred route comprises: determining not to display the preferred route when there is no difference between the default route and the preferred route, and determining to display the preferred route when the default route and the preferred route are different.

12. The method of claim 8, wherein the displaying of the preferred route comprises displaying the default route and the preferred route on a map image to be visually distinguishable from each other.

13. The method of claim 8, wherein the displaying of the preferred route comprises:
displaying first travel distance information and first travel time information corresponding to the default route; and displaying second travel distance information and second travel time information corresponding to the preferred route.

14. A computing device comprising:
at least one processor;
a communication interface configured to communicate with an external device;
a memory configured to load a computer program executed by the at least one processor; and
a storage configured to store the computer program,
wherein the computer program includes instructions for performing operations of:
receiving, from a user terminal, information on a route search request including information on a departure point and information on a destination point; acquiring first data on a plurality of actual driving routes of a user for reaching the destination point and second data on a number of times each of the plurality of actual driving routes has been driven, the plurality of actual driving routes being associated with the departure point; generating a preferred route from the departure point to the destination point based on the first data and the second data; and providing the preferred route to the user terminal.

15. The computing device of claim 14, wherein
the plurality of actual driving routes includes a first actual driving route and a second actual driving route different from the first actual driving route, and
the acquiring the first data comprises: comparing the first actual driving route with the second actual driving route; and when a difference between the first actual driving route and second actual driving route falls within a preset range, integrating data on the first actual driving route and data on the second actual driving route.

16. The computing device of claim 14, wherein the generating the preferred route comprises generating the preferred route using, among the plurality of actual driving routes, an actual driving route having a number of driving times equal to or greater than a preset threshold.

17. The computing device of claim 16, wherein the generating the preferred route comprises, when there are multiple actual driving routes with the number of driving times equal to or greater than the preset threshold, generating the preferred route using an actual driving route having a greatest number of driving times among the multiple actual driving routes.

18. The computing device of claim 16, wherein the generating the preferred route comprises generating a first connection route that connects the departure point and the actual driving route having the number of driving times equal to or greater than the preset threshold.

19. The computing device of claim 16, wherein the generating the preferred route includes generating a second connection route that connects the actual driving route having the number of driving times equal to or greater than the preset threshold and the destination point.

20. A computing device comprising:
at least one processor;
a communication interface configured to communicate with an external device;
a memory configured to load a computer program executed by the at least one processor; and
a storage configured to store the computer program,
wherein the computer program includes instructions for performing operations of:
receiving a user input requesting a route search to a destination;
receiving information on a default route to the destination, the default route being generated based on a default search option;
receiving information on a preferred route to the destination, the preferred route being generated based on data on a plurality of actual driving routes of a user for reaching the destination and data on a number of times each of the plurality of actual driving routes has been driven;
determining, based on a comparison result between the default route and the preferred route, whether to display the preferred route; and
in response to the preferred route being determined to be displayed, displaying the preferred route along with the default route on a screen of a user terminal.
